(19) United States
(12) Patent Application Publication
(10) Pub. No.: US 2024/0422533 A1
(43) Pub. Date: Dec. 19, 2024

(54) APPARATUS, METHOD, AND COMPUTER PROGRAM

(71) Applicant: Nokia Technologies Oy, Espoo (FI)

(72) Inventors: German PEINADO GOMEZ, Wroclaw (PL); Topuri BRAHMAIAH, Bangalore (IN); Mallikarjunudu MAKHAM, Bangalore (IN); Sireesha BOMMISETTY, Bangalore (IN); Saurabh KHARE, Bangalore (IN); Ranganathan MAVUREDDI DHANASEKARAN, Munich (DE); Chaitanya AGGARWAL, Munich (DE)

(21) Appl. No.: 18/671,659

(22) Filed: May 22, 2024

(30) Foreign Application Priority Data
Jun. 16, 2023 (GB) 2309046.7

(51) Int. Cl. H04W 12/03; H04W 12/041

(52) U.S. Cl. CPC H04W 12/03; H04W 12/041

(57) ABSTRACT

There is provided an apparatus, method, and computer program for causing an apparatus for a user equipment to perform: encrypting a digital asset using a first key to form an encrypted digital asset; providing the encrypted digital asset and an index for the encrypted digital asset to a first network function; and providing an identification of the encrypted digital asset to a first entity.

### TECHNICAL FIELD

The examples described herein generally relate to apparatus, methods, and computer programs, and more particularly (but not exclusively) to apparatus, methods and computer programs for apparatus.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3^{rd} Generation Partnership Project (3GPP), satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined therein. Examples include the so-called 5^{th} Generation (5G) standards.

### SUMMARY

According to a first aspect, there is provided an apparatus for a user equipment, the apparatus comprising means for performing: encrypting a digital asset using a first key to form an encrypted digital asset; providing the encrypted digital asset and an index for the encrypted digital asset to a first network function; and providing an identification of the encrypted digital asset to a first entity.

The means for providing the identification of the encrypted digital asset may comprise means for providing the first entity with a first identifier and at least one document identifier for identifying a document comprised in the encrypted digital asset.

The first identifier may comprise a subscriber identifier.

The first identifier may comprise a global public subscriber identifier.

The apparatus may comprise means for generating the first identifier by: inputting an authentication key into a second key derivation function; and combining an output of the second key derivation function with an identifier of a user of the user equipment to form the first identifier.

The means for combining may comprise means for combining the output of the second key derivation function with the identifier of the user and an identifier of an administrative domain to which the user is registered.

The apparatus may comprise means for: determining that a flag has been set to indicate that the first identifier is to be generated by inputting the authentication key into the first key derivation function prior to said inputting.

The apparatus may comprise means for performing: generating the first key by inputting a third key into a first key derivation function.

The means for generating the first key may further comprise inputting a random value and/or counter value into the first key derivation function.

The means for providing the identification may comprise means for providing the identification with a session establishment request.

The identification may comprise the index.

The index may comprise a random value, a counter value, and/or a key.

According to a second aspect, there is provided an apparatus for a first network function, the apparatus comprising means for performing: receiving an encrypted digital asset and an index for the encrypted digital asset; receiving, from a first entity, a request for the encrypted digital asset; and providing the encrypted digital asset and the index to the first entity.

The apparatus may comprise means for performing: determining that the first entity is authorised to receive the encrypted digital asset prior to providing the encrypted digital asset to the first entity.

The index may comprise a random value, a counter value, and/or a key.

According to a third aspect, there is provided an apparatus for a first entity, the apparatus comprising means for performing: receiving, from a user equipment, an identification of an encrypted digital asset; retrieving the encrypted digital asset from a first network function; receiving an index for the encrypted digital asset from the user equipment or the first network function; retrieving a first decryption key from an authentication function using the index and the identification of the encrypted digital asset; and decrypting the encrypted digital asset.

The index may comprise a random value, a counter value, and/or a key.

According to a fourth aspect, there is provided an apparatus for an authentication function, the apparatus comprising means for performing: receiving, from a first entity, a request for a first decryption key for decrypting an encrypted digital asset, the request comprising an index for the encrypted digital asset; obtaining the decryption key using the index; and providing the decryption key to the first entity.

The means for obtaining the decryption key may comprise means for using a value of the received index and an identification of the encrypted digital asset to generate the decryption key.

The means for obtaining the decryption key may comprise means for using a value of the received index and an identification of the encrypted digital asset to retrieve a previously generated decryption key.

The index may comprise a random value, a counter value, and/or a key.

According to a fifth aspect, there is provided an apparatus for a user equipment, the apparatus comprising: at least one processor; and at least one memory comprising code that, when executed by the at least one memory, causes the apparatus to perform: encrypting a digital asset using a first key to form an encrypted digital asset; providing the encrypted digital asset and an index for the encrypted digital asset to a first network function; and providing an identification of the encrypted digital asset to a first entity.

The providing the identification of the encrypted digital asset may comprise providing the first entity with a first identifier and at least one document identifier for identifying a document comprised in the encrypted digital asset.

The first identifier may comprise a subscriber identifier.

The first identifier may comprise a global public subscriber identifier.

The apparatus may be caused to perform: generating the first identifier by: inputting an authentication key into a second key derivation function; and combining an output of the second key derivation function with an identifier of a user of the user equipment to form the first identifier.

The combining may comprise combining the output of the second key derivation function with the identifier of the user and an identifier of an administrative domain to which the user is registered.

The apparatus may be caused to perform: determining that a flag has been set to indicate that the first identifier is to be generated by inputting the authentication key into the first key derivation function prior to said inputting.

The apparatus may be caused to perform: generating the first key by inputting a third key into a first key derivation function.

The generating the first key may further comprise inputting a random value and/or counter value into the first key derivation function.

The providing the identification may comprise providing the identification with a session establishment request.

The identification may comprise the index.

The index may comprise a random value, a counter value, and/or a key.

According to a sixth aspect, there is provided an apparatus for a first network function, the apparatus comprising: at least one processor; and at least one memory comprising code that, when executed by the at least one processor, causes the apparatus to perform: receiving an encrypted digital asset and an index for the encrypted digital asset; receiving, from a first entity, a request for the encrypted digital asset; and providing the encrypted digital asset and the index to the first entity.

The apparatus may be caused to perform: determining that the first entity is authorised to receive the encrypted digital asset prior to providing the encrypted digital asset to the first entity.

The index may comprise a random value, a counter value, and/or a key.

According to a seventh aspect, there is provided an apparatus for a first entity, the apparatus comprising at least one processor; and at least one memory comprising code that, when executed by the at least one processor, causes the apparatus to perform: receiving, from a user equipment, an identification of an encrypted digital asset; retrieving the encrypted digital asset from a first network function; receiving an index for the encrypted digital asset from the user equipment or the first network function; retrieving a first decryption key from an authentication function using the index and the identification of the encrypted digital asset; and decrypting the encrypted digital asset.

The index may comprise a random value, a counter value, and/or a key.

According to an eighth aspect, there is provided an apparatus for an authentication function, the apparatus comprising: at least one processor; and at least one memory comprising code that, when executed by the at least one processor, causes the apparatus to perform: receiving, from a first entity, a request for a first decryption key for decrypting an encrypted digital asset, the request comprising an index for the encrypted digital asset; obtaining the decryption key using the index; and providing the decryption key to the first entity.

The obtaining the decryption key may comprise using a value of the received index and an identification of the encrypted digital asset to generate the decryption key.

The obtaining the decryption key may comprise using a value of the received index and an identification of the encrypted digital asset to retrieve a previously generated decryption key.

The index may comprise a random value, a counter value, and/or a key.

According to a ninth aspect, there is provided a method for an apparatus for a user equipment, the method comprising: encrypting a digital asset using a first key to form an encrypted digital asset; providing the encrypted digital asset and an index for the encrypted digital asset to a first network function; and providing an identification of the encrypted digital asset to a first entity.

The providing the identification of the encrypted digital asset may comprise providing the first entity with a first identifier and at least one document identifier for identifying a document comprised in the encrypted digital asset.

The first identifier may comprise a subscriber identifier.

The first identifier may comprise a global public subscriber identifier.

The method may comprise generating the first identifier by: inputting an authentication key into a second key derivation function; and combining an output of the second key derivation function with an identifier of a user of the user equipment to form the first identifier.

The combining may comprise combining the output of the second key derivation function with the identifier of the user and an identifier of an administrative domain to which the user is registered.

The method may comprise: determining that a flag has been set to indicate that the first identifier is to be generated by inputting the authentication key into the first key derivation function prior to said inputting.

The method may comprise: generating the first key by inputting a third key into a first key derivation function.

The generating the first key may further comprise inputting a random value and/or counter value into the first key derivation function.

The providing the identification may comprise providing the identification with a session establishment request.

The identification may comprise the index.

The index may comprise a random value, a counter value, and/or a key.

According to a tenth aspect, there is provided a method for an apparatus for a first network function, the method comprising: receiving an encrypted digital asset and an index for the encrypted digital asset; receiving, from a first entity, a request for the encrypted digital asset; and providing the encrypted digital asset and the index to the first entity.

The method may comprise: determining that the first entity is authorised to receive the encrypted digital asset prior to providing the encrypted digital asset to the first entity.

The index may comprise a random value, a counter value, and/or a key.

According to an eleventh aspect, there is provided a method for an apparatus for a first entity, the method comprising: receiving, from a user equipment, an identification of an encrypted digital asset; retrieving the encrypted digital asset from a first network function; receiving an index for the encrypted digital asset from the user equipment or the first network function; retrieving a first decryption key from an authentication function using the index and the identification of the encrypted digital asset; and decrypting the encrypted digital asset.

The index may comprise a random value, a counter value, and/or a key.

According to a twelfth aspect, there is provided a method for an apparatus for an authentication function, the method comprising: receiving, from a first entity, a request for a first decryption key for decrypting an encrypted digital asset, the request comprising an index for the encrypted digital asset; obtaining the decryption key using the index; and providing the decryption key to the first entity.

The obtaining the decryption key may comprise using a value of the received index and an identification of the encrypted digital asset to generate the decryption key.

The obtaining the decryption key may comprise using a value of the received index and an identification of the encrypted digital asset to retrieve a previously generated decryption key.

The index may comprise a random value, a counter value, and/or a key.

According to a thirteenth aspect, there is provided an apparatus for a user equipment, the apparatus comprising: encrypting circuitry for encrypting a digital asset using a first key to form an encrypted digital asset; providing circuitry for providing the encrypted digital asset and an index for the encrypted digital asset to a first network function; and providing circuitry for providing an identification of the encrypted digital asset to a first entity.

The providing circuitry for providing the identification of the encrypted digital asset may comprise providing circuitry for providing the first entity with a first identifier and at least one document identifier for identifying a document comprised in the encrypted digital asset.

The first identifier may comprise a subscriber identifier.

The first identifier may comprise a global public subscriber identifier.

The apparatus may comprise generating circuitry for generating the first identifier by: inputting an authentication key into a second key derivation function; and combining an output of the second key derivation function with an identifier of a user of the user equipment to form the first identifier.

The combining circuitry for combining may comprise combining circuitry for combining the output of the second key derivation function with the identifier of the user and an identifier of an administrative domain to which the user is registered.

The apparatus may comprise: determining circuitry for determining that a flag has been set to indicate that the first identifier is to be generated by inputting the authentication key into the first key derivation function prior to said inputting.

The apparatus may comprise: generating circuitry for generating the first key by inputting a third key into a first key derivation function.

The generating circuitry for generating the first key may further comprise inputting a random value and/or counter value into the first key derivation function.

The proving circuitry for providing the identification may comprise providing circuitry for providing the identification with a session establishment request.

The identification may comprise the index.

The index may comprise a random value, a counter value, and/or a key.

According to a fourteenth aspect, there is provided an apparatus for a first network function, the apparatus comprising: receiving circuitry for receiving an encrypted digital asset and an index for the encrypted digital asset; receiving circuitry for receiving, from a first entity, a request for the encrypted digital asset; and providing circuitry for providing the encrypted digital asset and the index to the first entity.

The apparatus may comprise: determining circuitry for determining that the first entity is authorised to receive the encrypted digital asset prior to providing the encrypted digital asset to the first entity.

The index may comprise a random value, a counter value, and/or a key.

According to a fifteenth aspect, there is provided an apparatus for a first entity, the apparatus comprising: receiving circuitry for receiving, from a user equipment, an identification of an encrypted digital asset; retrieving circuitry for retrieving the encrypted digital asset from a first network function; receiving circuitry for receiving an index for the encrypted digital asset from the user equipment or the first network function; retrieving circuitry for retrieving a first decryption key from an authentication function using the index and the identification of the encrypted digital asset; and decrypting circuitry for decrypting the encrypted digital asset.

The index may comprise a random value, a counter value, and/or a key.

According to a sixteenth aspect, there is provided an apparatus for an authentication function, the apparatus comprising: receiving circuitry for receiving, from a first entity, a request for a first decryption key for decrypting an encrypted digital asset, the request comprising an index for the encrypted digital asset; obtaining circuitry for obtaining the decryption key using the index; and proving circuitry for providing the decryption key to the first entity.

The obtaining circuitry for obtaining the decryption key may comprise using circuitry for using a value of the received index and an identification of the encrypted digital asset to generate the decryption key.

The obtaining circuitry for obtaining the decryption key may comprise using circuitry for using a value of the received index and an identification of the encrypted digital asset to retrieve a previously generated decryption key.

The index may comprise a random value, a counter value, and/or a key.

According to a seventeenth aspect, there is provided non-transitory computer readable medium comprising program instructions for causing an apparatus for a user equipment to perform: encrypting a digital asset using a first key to form an encrypted digital asset; providing the encrypted digital asset and an index for the encrypted digital asset to a first network function; and providing an identification of the encrypted digital asset to a first entity.

The providing the identification of the encrypted digital asset may comprise providing the first entity with a first identifier and at least one document identifier for identifying a document comprised in the encrypted digital asset.

The first identifier may comprise a subscriber identifier.

The first identifier may comprise a global public subscriber identifier.

The apparatus may be caused to perform: generating the first identifier by: inputting an authentication key into a second key derivation function; and combining an output of the second key derivation function with an identifier of a user of the user equipment to form the first identifier.

The combining may comprise combining the output of the second key derivation function with the identifier of the user and an identifier of an administrative domain to which the user is registered.

The apparatus may be caused to perform: determining that a flag has been set to indicate that the first identifier is to be generated by inputting the authentication key into the first key derivation function prior to said inputting.

The apparatus may be caused to perform: generating the first key by inputting a third key into a first key derivation function.

The generating the first key may further comprise inputting a random value and/or counter value into the first key derivation function.

The providing the identification may comprise providing the identification with a session establishment request.

The identification may comprise the index.

The index may comprise a random value, a counter value, and/or a key.

According to an eighteenth aspect, there is provided non-transitory computer readable medium comprising program instructions for causing an apparatus for a first network function to perform: receiving an encrypted digital asset and an index for the encrypted digital asset; receiving, from a first entity, a request for the encrypted digital asset; and providing the encrypted digital asset and the index to the first entity.

The apparatus may be caused to perform: determining that the first entity is authorised to receive the encrypted digital asset prior to providing the encrypted digital asset to the first entity.

The index may comprise a random value, a counter value, and/or a key.

According to a nineteenth aspect, there is provided non-transitory computer readable medium comprising program instructions for causing an apparatus for a first entity to perform: receiving, from a user equipment, an identification of an encrypted digital asset; retrieving the encrypted digital asset from a first network function; receiving an index for the encrypted digital asset from the user equipment or the first network function; retrieving a first decryption key from an authentication function using the index and the identification of the encrypted digital asset; and decrypting the encrypted digital asset.

The index may comprise a random value, a counter value, and/or a key.

According to a twentieth aspect, there is provided non-transitory computer readable medium comprising program instructions for causing an apparatus for an authentication function to perform: receiving, from a first entity, a request for a first decryption key for decrypting an encrypted digital asset, the request comprising an index for the encrypted digital asset; obtaining the decryption key using the index; and providing the decryption key to the first entity.

The obtaining the decryption key may comprise using a value of the received index and an identification of the encrypted digital asset to generate the decryption key.

The obtaining the decryption key may comprise using a value of the received index and an identification of the encrypted digital asset to retrieve a previously generated decryption key.

The index may comprise a random value, a counter value, and/or a key.

According to a twenty first aspect, there is provided a computer program product stored on a medium that may cause an apparatus to perform any method as described herein.

According to a twenty second aspect, there is provided an electronic device that may comprise apparatus as described herein.

According to a twenty third aspect, there is provided a chipset that may comprise an apparatus as described herein.

### BRIEF DESCRIPTION OF THE DRAWINGS

Some examples, will now be described, merely by way of illustration only, with reference to the accompanying drawings in which:

FIG. 1 shows an example representation of a 5G system;

FIG. 2 shows an example representation of a network apparatus;

FIG. 3 shows an example representation of a user equipment;

FIGS. 4 to 7 illustrate example signalling; and

FIGS. 8 to 11 illustrate example operations that may be performed by apparatus described herein.

### DETAILED DESCRIPTION

The following describes example operations that may be performed in relation to facilitating security when a user's metaverse data is stored in a network system.

In the following, certain examples are explained with reference to devices that are often capable of communication via a wireless cellular system and mobile communication systems serving such mobile communication devices. For brevity and clarity, the following describes such examples with reference to a 5G wireless communication system. However, it is understood that such examples are not limited to 5G wireless communication systems, and may, for example, be applied to other wireless communication systems (e.g., current 6^{th} Generation (6G) proposals, IEEE 802.11, among others).

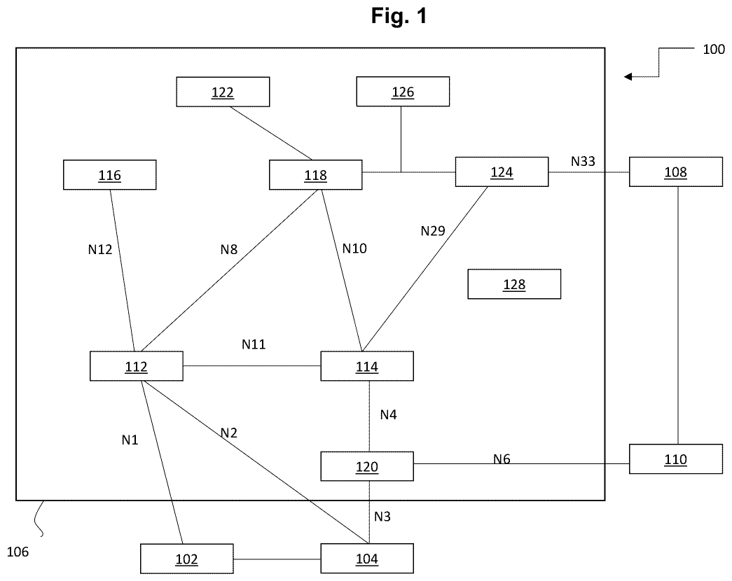

Before describing in detail the examples, certain facets of a 5G wireless communication system are briefly explained with reference to FIGS. 1 to 3.

FIG. 1 shows an example representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110. The UE may subscribe to receive at least one service from an AF. To help facilitate user traffic for the service to be delivered to the UE efficiently, the network may classify user traffic (e.g., Internet Protocol (IP) flows) into different service data flows (SDFs) having different Quality of Service (QoS) classes based on the type of service being provided through the SDFs. Different QoS rules may be applied to each SDF.

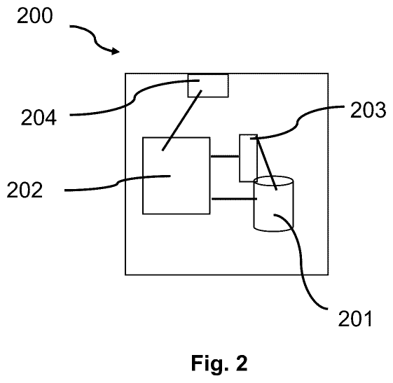

FIG. 2 shows an example of a control apparatus for a communication system, for example to be coupled to and/or for controlling a station of an access system, such as a RAN node, e.g. a base station, gNB, a central unit of a cloud architecture or a node of a core network such as an Access and Mobility Management Function (AMF) or User Plane Function (UPF), a scheduling entity such as a spectrum management entity, or a server or host, for example an apparatus hosting an Network Repository Function (NRF), Network Data Analytics Function (NWDAF), AMF, Session Management Function (SMF), Unified Data Management/Unified Data Repository (UDM/UDR), and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions. References to “code” herein are understood to refer to software code, and vice versa.

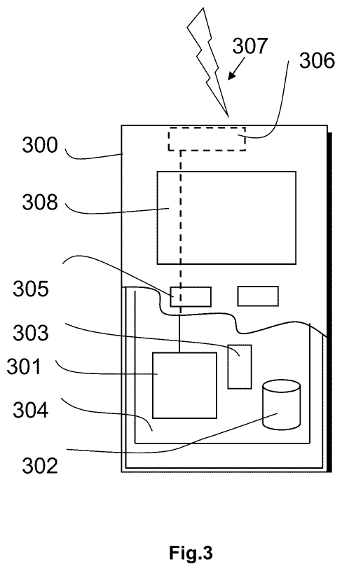

An example wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., Universal Serial Bus (USB) dongle), personal data assistant (PDA) or a tablet provided with wireless communication capabilities, or a Virtual Reality device, Augmented Reality device, Mixed Reality device, or other Extended Reality such as a virtual reality headset, or any combinations of these or the like. A mobile communication device may provide, for example, communication of data for carrying communications such as voice, electronic mail (email), text message, multimedia and extended reality media and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may, for example, be a mobile device, that is, a device not fixed to a particular location, or it may be a stationary device. The wireless device may utilize human interaction for communication, or may not utilize human interaction for communication. As described herein, the terms UE, or “user” (more informally) can be used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be configured internally or externally to the wireless device.

A wireless device is typically provided with at least one data processing entity 301, at least one memory 302 and other possible components 303 for use in software code and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface, such as keypad 305, voice commands, touch sensitive screen or pad, combinations thereof or the like. A display or virtual reality headset/glasses 308, a speaker and a microphone can be also provided. Furthermore, a wireless communication device may comprise appropriate connectors (wired and/or wireless) to other devices and/or for connecting external accessories, for example hands-free equipment, thereto.

3GPP has issued a number of releases (Rel) for defining operating communication protocols related to a communications network. Currently, objectives and work are being set in relation to Release 18 (Rel. 18) and Rel. 19.

One of the study areas for Rel. 19 is contained in 3GPP TR 22.856, which relates to a feasibility study on localized mobile Metaverse services.

In the context of telecommunications, a Metaverse relates to a highly interactive three-dimensional virtual domain in which real-world conditions can be simulated by combining a multitude of Internet functions. It is a spectrum of digitally augmented worlds, realities, and business models. In the Metaverse, people can use personal avatars to execute all kinds of activities, whether work or recreation in an immersive digital environment. The term “Metaverse” covers a wide variety of location agnostic service experiences, from workplace tools to games and community platforms. It generally refers to shared and immersive digital service experiences (i.e. mobile metaverse services) that people can experience by means of using extended reality (XR) devices.

To help facilitate such an environment, 3GPP TR 22.856 discusses the use of digital assets and digital asset containers.

Under current 3GPP specifications, a digital asset may be considered to be anything that is stored digitally and is uniquely identifiable that can be used to realize value. Examples of a digital asset may comprise a digital image (e.g., an avatar that digitally represents a user), cryptocurrencies, tokens such as Non-Fungible Tokens (NFTs), purchased items, user identifiers (e.g., driving license information, and/or passport information), credit card information, etc.

A digital asset may be comprised in a digital asset container (DAC). Under current 3GPP specifications digital asset container may be considered to be a virtual container in which a user holds their digital assets. This digital asset container may be arranged to also allow to provide proof that the data contained therein relates to specific user without disclosing information (to prove an element of the identity without revealing the personal data). Some of the information (e.g., digital assets) stored in this digital asset container can be certified (such as identifiers) when that data has already been authenticated upstream and is encrypted.

To ensure a seamless user experience across metaverse services, network operators may offer digital asset management services that allow users to certify certain information, such as IDs. These services support multiple user identities, each representing different aspects of the user's life, such as their professional role and private life. As a result, each user identity may have its own set of information stored in the associated digital asset container, and this information can be managed differently based on the security requirements of the service. As several different use cases for the Metaverse have been considered, each use case may be associated with different levels of security for storage and/or access of a digital access. For example, the information associated with virtual banking requires a higher level of security in mobile communication due to the sensitive nature of the information, compared to that associated with virtual gaming.

For telecommunications applications, it is assumed that a 5G system (and beyond 5G) will support a user managing, storing and updating information associated with the user (e.g., to securely manage at least one digital asset comprised in a digital asset container), and will support the retrieval of such information from an authorized third party (or to an authorized third party via a request from an application platform). The 5G system may be further able to deploy mechanisms for certifying the authenticity of the information of a digital asset container (or similar) associated with a user, and to protect against spoofing attacks of the customer's digital asset container.

For example, according to use cases defined in the Metaverse (3GPP TR 22.856), a digital asset container (DAC) (like a digital wallet) may be maintained in 5GC. In this “wallet” a user can store any information associated with that user, including, for example, credit card information, user identifiers, receipts, etc. More precisely, a 5G system may allow a user to securely store and update the information (digital assets) in the digital asset container, as well as authorized third parties to retrieve the information from the digital asset container associated with this user. Further, it is preferred that only authorized third parties are to be able to retrieve the information from a DAC.

However, in 5G these concepts have not yet been defined, and so there is no way to realize these requirements using current network mechanisms.

The following aims to address at least one of the above-mentioned issues in 3GPP systems (including 5G and beyond) by providing at least one mechanism for a facilitating storing and managing digital assets.

In particular, the following introduces a new network function (NF), labelled herein as a Digital Asset Container (DAC) NF that cooperates to realize securely storing the information and the authorization to retrieve the information.

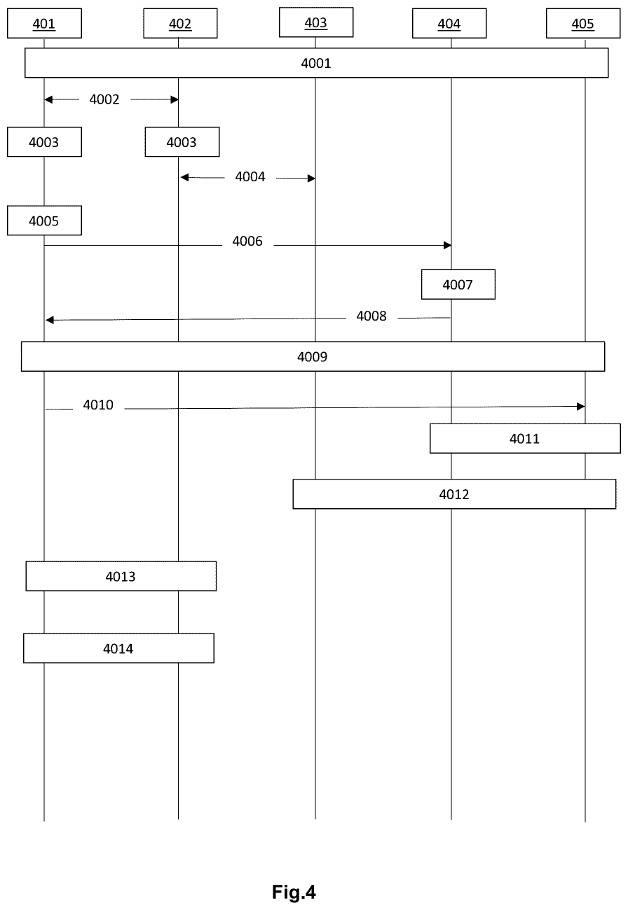

There are a plurality of different ways in such a new DAC NF may be implemented for facilitating DAC management. These are illustrated with respect to at least FIGS. 4 to 7.

A first example mechanism is illustrated with respect to FIG. 4. In this first example, a DAC Key identity (DAC-KID) and a Metaverse Key (K_{Metaverse}) are generated using a plurality of user-specific parameter values associated with the UE. For example, these user-specific parameter values may comprise values for a key-Authentication Server Function (K_{AUSF}), Subscription Permanent Identifier (SUPI) and/or other fixed parameters stored at UE and/or an Authentication Server Function (AUSF).

The AUSF may store the keys, DAC-KID and K_{Metaverse}, at an Authentication and Key Management for Applications (AKMA) Anchor function (AAnF). The DAC-KID and K_{Metaverse} generation may be controlled by the use of a “Metaverse Key Flag” that can hold values indicating, for example, true or false. The value of the flag may be configured by an operations and management (OAM) entity and/or the operator.

The content that the UE wants to store at the 5GS is herein called DAC content (and may correspond to digital assets comprised in a DAC). The DAC content may be encrypted by the UE using the K_{Metaverse} and is sent to the DAC NF for storage along with the DAC-KID.

The UE connects to a Metaverse AF, providing the DAC-KID to the Metaverse AF. The Metaverse AF may be considered to be an application function (AF) that interacts with a 3GPP Core Network in order to provide at least one service to a user/client of the Metaverse AF. When the Metaverse AF subsequently signals an information request to the DAC NF with the DAC-KID, encrypted DAC content will be shared with the Metaverse AF. Further to this, the Metaverse AF can retrieve K_{Metaverse} from the AAnF using DAC-KID to decrypt the DAC content.

In this example, the 5GS has control of both key generation and DAC storage, albeit at different entities. The DAC NF, by default, does not obtain keys from an anchoring function.

This process is illustrated with respect to FIG. 4.

FIG. 4 illustrates signalling that may be performed between a UE 401, an AUSF 402, an AAnF and/or UDM 403, a DAC NF 404, and a Metaverse AF 405.

During 4001, it is assumed that the Metaverse key flag is set to true to indicate that DAC-KID and K_{Metaverse} are to be generated. If the Metaverse key flag had been set to false, then neither K_{Metaverse} nor the DAC-KID are generated.

During 4002, the UE 401 and the AUSF 402 exchange signalling. This signalling may be for performing an authentication operation between the UE 401 and the AUSF 402 (e.g., a primary authentication operation). The authentication operation may result in each of the UE 401 and the AUSF 402 generating an authentication key, K_{AUSF}.

During 4003, each of the UE 401 and the AUSF 402 generate DAC Key ID (DAC-KID) and Metaverse Key (K_{Metaverse}). These keys may be generated based on the value of at least one parameter stored at the UE and AUSF for a subscriber of the UE. For example, these keys may be generated using K_{AUSF}, SUPI, and/or other parameters at the UE and AUSF.

In the example of FIG. 4, at least one of the following parameters may be used to form an input, S, into a key derivation function when deriving K_{Metaverse} from K_{AUSF}:
FC=0xWX;
P0=“METAVERSE”;
L0=length of “METAVERSE”; (i.e. 0x00 0x09)
P1=SUPI;
L1=length of SUPI.
   Further, the input key, KEY, to the key derivation function when deriving K_{Metaverse} may be the K_{AUSF}.

Further, the DAC-KID may be generated by inputting K_{AUSF}, SUPI, and an indication that a DAC key is to be generated into a key derivation function that outputs a DAC-ID. The DAC-KID may subsequently be generated to reflect two function parts: a username portion (comprising the DAC-ID generated by the key derivation function and a routing indicator (RID), which is an identifier obtained from signalling from the UDM to the AUSF, and which is currently defined in TS 33.535), and a realm portion (e.g., a home network identifier or some other domain identifier indicating a home domain of the UE 401).

When deriving a DAC Key ID, DAC-KID from K_{AUSF}, at least one of the following parameters may be used to form the input, S, to the key derivation function:
FC=0xXY;
P0=“DAC”;
L0=length of “DAC”; (i.e. 0x00 0x03)
P1=SUPI;
L1=length of SUPI.
   Moreover, the input key, KEY, to the key derivation function when deriving DAC-KID may be the K_{AUSF}.

During 4004, the AUSF 402 exchange signaling with the AAnF 403. This signalling may comprise the DAC-KID and K_{Metaverse}. This signalling may comprise an Anchor Key register request from the AUSF 402 to the AAnF 403, and an Anchor Key response from the AAnF 403 to the AUSF 402.

During 4005, the UE determines to use K_{Metaverse} to encrypt DAC content, and performs said encryption.

During 4006, the UE 401 signals the DAC NF 404. This signalling may comprise the encrypted DAC content. This signalling may comprise the DAC-KID. This signalling may comprise a request to store the encrypted DAC content. This signalling may be performed in any of a plurality of different ways (e.g., over Non-Access Stratum (NAS) signalling, and/or via a user plane (e.g., via an application function)).

During 4007, the DAC NF 404 stores the encrypted DAC content with the DAC-KID.

During 4008, the DAC NF 404 signals the UE 401. This signalling may comprise an indication that the request to store the encrypted DAC content has been successful.

During 4009, the Metaverse key flag is set to false. This Metaverse key flag may set to false in response to 4008 being performed. Stated differently, this Metaverse key flag may be set to false in response to the DAC NF 404 signals an indication to the UE 401 that the request to store the encrypted DAC content has been successful.

During 4010, the UE 401 signals the Metaverse AF 405. This signaling may comprise a request to establish a session. This signalling may comprise the DAC-KID.

During 4011, the Metaverse AF 405 and the DAC NF 404 exchange signalling. This signalling may be for establishing that the Metaverse AF 405 is authorized to retrieve DAC information about a UE from the DAC NF 404. The signalling may be for establishing that the Metaverse AF 405 is authorized to retrieve DAC information about the UE 401 from the DAC NF 404. This signalling may comprise the Metaverse AF 405 signalling the DAC-KID to the DAC NF 404.

Assuming that the Metaverse AF 405 is authorized to retrieve data related to the UE 401, this signalling may cause the Metaverse AF 405 to retrieve encrypted DAC content stored at the DAC NF 404 after the DAC NF 404 has determined that the provided DAC-KID from the Metaverse 405 is stored at the DAC NF 404 with associated encrypted DAC content.

During 4012, the Metaverse AF 405 and the AAnF 403 exchange signalling. This signalling enables the Metaverse AF 405 to obtain K_{Metaverse} from the AAnF 403 after the Metaverse AF 405 signals the DAC-KID to the AAnF 403. The Metaverse AF 405 may use the obtained K_{Metaverse} to decrypt the DAC content. The Metaverse AF 405 may use the decrypted DAC content for any service provided by the Metaverse AF 405 to the UE 401 (e.g., for fetching at least one of: a user identity document, an avatar for a gaming application, etc.).

During 4013, the UE 401 and AUSF 402 exchange signalling for re-authenticating each other.

As the Metaverse key flag is currently set to false, during 4014, the UE 401 and AUSF 402 abstain from generating a Metaverse key and/or DAC-KID.

Stated differently, when the “Metaverse key flag” is disabled, then for each re-authentication, the new DAC-KID or Key K_{Metaverse} will not be generated. This flag can be dynamically enabled or disabled according to requirement of user to upload all new documents in DAC. When the “Metaverse key flag” is enabled, then for each re-authentication, the new DAC-KID or Key K_{Metaverse} will be generated. This flag is configuration parameter which can be enabled or disabled dynamically.

In this first example of FIG. 4, as there is a 1^{st} AKMA based key used, there is no freshness and therefore the DAC-KID will be same.

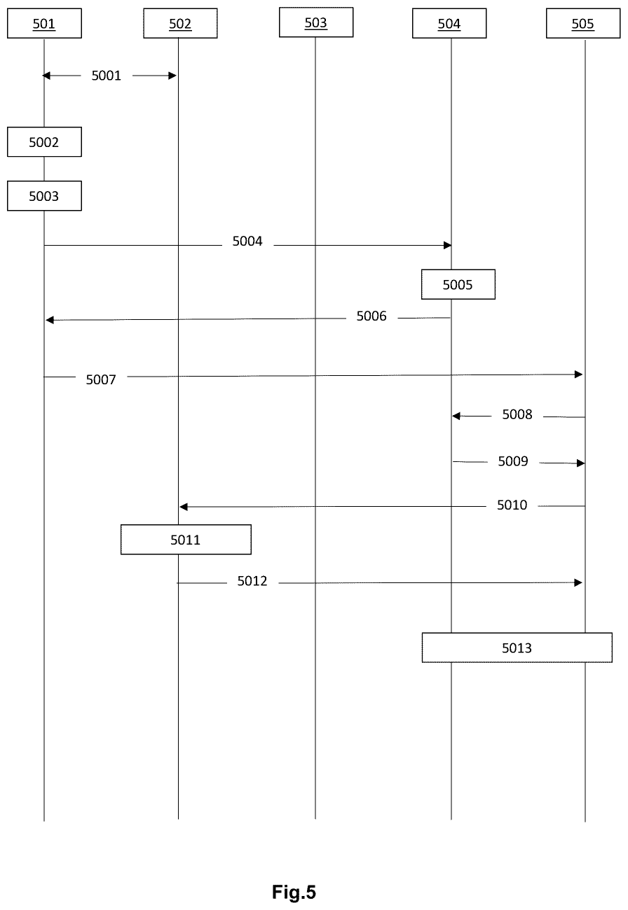

FIG. 5 illustrates a second example mechanism in which key “freshness” is improved relative to the example operation of FIG. 4. In the present context, a key “freshness” relates to a novelty of a key, with more recently generated keys being considered “fresher” than keys generated longer ago. Stated differently, newer generated keys are fresher than older generated keys.

In the example of FIG. 5, a new encryption key at the UE and the network is generated based on a long-term key (K) and a value of a random number or a counter. The long-term key (K) may be considered to be a symmetric key for a particular user. In 3GPP, the long term key is defined in TS 33.501, and is a symmetric key stored in the Universal Subscriber Identity Module (USIM) and/or UDM for a specific user. The long-term key is stored in a secure environment, and is used, after primary authentication, to derive all key hierarchy.

The UE encrypts DAC content using the generated new encryption key, and stores the encrypted DAC content using a 5GC (e.g., via a DAC NF). An AF may subsequently retrieve the encrypted DAC content using the Metaverse UE context from the DAC NF using a network exposure function. The Metaverse UE context may be, for example, based on an identifier such as a global public subscriber identifier (GPSI), a Tag ID (=passport), a document Id (1 or 2 . . . ), etc. Since the content will be encrypted, the AF may obtain a decryption key (e.g., from an AUSF) for decrypting the DAC content. Further, the DAC NF may store user documents (e.g., DAC content) in a way that maintains a mapping between a document identifier/TAG ID and document information in order that this information may be used to retrieve at least one specific document/DAC content.

These processes are illustrated with respect to FIG. 5.

FIG. 5 illustrates signalling that may be performed between a UE 501, an authentication function 502, a DAC NF 503, a Network Exposure Function (NEF) 504, and a Metaverse AF 505.

During 5001, the UE 501 and the AUSF 502 perform a primary authentication mechanism for authenticating each other. It is understood that any primary authentication mechanism may be used (similar to any other reference herein to primary authentication). Example primary authentication mechanisms mentioned in 3GPP TS 33.501 comprise 5G Authentication and Key Agreement (AKA) and/or Extensible Authentication Protocol (EAP) AKA.

During 5002, the UE 501 generates a K_{Metaverse}. This may be performed by inputting a long term key, K_{long}, a counter value (or random value), and a subscriber-specific parameter (e.g., SUPI), into a key derivation function, which uses these inputs to output K_{Metaverse}.

For example, when deriving a K_{Metaverse} from k_{long}, at least one of the following parameters may be used to form an input, S, to the KDF:
FC=0xWX;
P0=“METAVERSE”;
L0=length of “METAVERSE”; (i.e. 0x00 0x09)
P1=SUPI;
L1=length of SUPI.
P2=COUNTER value or RAND;
L1=length of Counter or length of RAND.
   The input key, KEY, for deriving K_{Metaverse} may be K_{long}. The initial value of P2 may be zero, and the value of P2 may change (e.g., increment by one) for each subsequent generation of K_{Metaverse}.

The UE may determine to generate K_{Metaverse} after being configured to do so by the 5G network. For example, when the UE subscribes to a DAC service, the network may signal an indication to the UE to generate K_{Metaverse}. This indication can be sent to the UE via a UE parameters update (UPU) command procedure and/or a UE configuration update (UCU) command procedure.

During 5003, the UE 501 uses the generated K_{Metaverse} to encrypt DAC content.

During 5004, the UE 501 signals the DAC NF. This signalling may comprise a request for storing the encrypted DAC content. This signalling may comprise the encrypted DAC content. This signalling may comprise the value of P2, mentioned above (e.g., a counter or random value used for deriving K_{Metaverse}).

During 5005, the DAC NF 503 stores the received encrypted DAC content and the received P2 value.

During 5006, the DAC NF 503 signals the UE 501. This signalling may indicate that the encrypted DAC content has been successfully stored.

During 5007, the UE 501 signals the Metaverse AF 505. This signalling may comprise a session establishment request.

During 5008, the Metaverse AF 505 signals the DAC NF 503. This signalling may comprise a request for the encrypted DAC information. This signalling may comprise an indication of the subscriber identifier (e.g., GPSI, such as a phone number), an indication of a Tag ID (e.g., to indicate a type of document, such as passport) and/or document number (e.g., when multiple documents of the same type are stored for a user, then a value (e.g., 1 or 2) may be used to distinguish therebetween). The request for the encrypted DAC information may comprise information for identifying the encrypted DAC. The information for identifying the encrypted DAC may be received from the UE (e.g., during the request of 5007 or during some other time).

During 5009, the DAC NF 503 signals the Metaverse AF 505. This signalling may comprise the encrypted DAC information associated with the Tag ID and/or document number indicated during 5008. This signalling may comprise the P1 value (e.g., the counter value or RAND value) used for deriving K_{Metaverse}.

During 5010, the Metaverse AF 505 signals the authentication function 502 to request K_{Metaverse}. This signalling may comprise the P1 value received during 5009. This signaling may comprise an identifier of the subscriber (e.g., the GPSI).

During 5011, the authentication function generates K_{Metaverse}. This operation may be analogous to the operation performed during 5002. The authentication function may convert the GPSI to SUPI by signalling a request for the SUPI to a unified data management entity that comprises the GPSI.

During 5012, the authentication function 502 signals the Metaverse AF 505. This signalling may comprise K_{Metaverse}.

During 5013, the Metaverse AF 505 uses the received K_{Metaverse} of 5012 to decrypt the encrypted DAC received during 5009. The Metaverse AF 505 may use the decrypted DAC content for any service provided by the Metaverse AF 505 to the UE 501 (e.g., for fetching at least one of: a user identity document, an avatar for a gaming application, etc.).

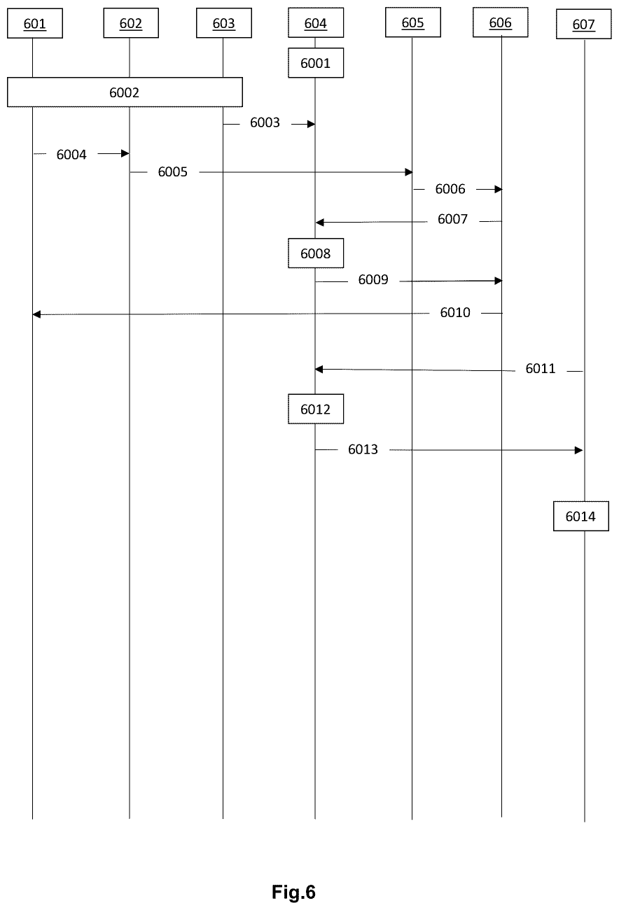

FIG. 6 illustrates another (third) example mechanism for facilitating storage and/or retrieval of digital assets in a 3GPP system.

FIG. 6 illustrates signalling that may be performed between a UE 601, a radio access network (RAN) 602, an authentication function 603, a DAC NF 604, a user plane function (UPF) 605, an external AF 606, and a Metaverse AF 607. The external AF 606 and Metaverse AF 607 may be located outside of the 5G network (e.g., over the internet). The RAN 602, the authentication function 603, the DAC NF 604, and UPF 605 may be located in a 5GS.

During 6001, the DAC NF 604 maintains a plurality of multiple digital documents (e.g., digital assets) stored in a Digital Asset Container (DAC), with each digital document being associated with a list of authorized Metaverse AFs that are allowed to retrieve information from a DAC.

During 6002, the UE 601 and authentication function 603 perform primary authentication. During 6002, the UE 601 and authentication function 603 may each generate K_{AUSF}, and K_{Metaverse}. K_{Metaverse} may be generated as described above in relation to any of FIGS. 4 and 5.

During 6003, the authentication function 603 signals the DAC NF 604. This signalling may provide the DAC NF 604 with the generated K_{Metaverse}.

During 6004, the UE 601 signals the RAN 602. This signalling may send encrypted digital documents (e.g., digital documents that are encrypted using K_{Metaverse} as an encryption key) and a list of authorized application functions, tag identifiers and document numbers for each digital documents.

During 6005, the RAN 602 signals the UPF 605. This signalling may send the encrypted digital documents (e.g., digital documents that are encrypted using K_{Metaverse} as an encryption key) and the list of authorized application functions, tag identifiers and document numbers for each digital documents.

During 6006, the UPF 605 signal the external AF 606. This signalling may send the encrypted digital documents (e.g., digital documents that are encrypted using K_{Metaverse} as an encryption key) and the list of authorized application functions, tag identifiers and document numbers for each digital documents.

During 6007, the external AF 606 signals the DAC NF 604. This signalling may send the encrypted digital documents (e.g., digital documents that are encrypted using K_{Metaverse} as an encryption key) and the list of authorized application functions, tag identifiers and document numbers for each digital documents.

During 6008, the DAC NF 604 uses the previously received K_{Metaverse} to decrypt the digital documents sent thereto. The DAC NF may generate a new key using document details (tag, number, etc.) input into a key derivation function known only to DAC-NF, encrypt the digital documents using this new key, and store the newly encrypted digital documents securely. The use of this new key means that K_{Metaverse} may be deleted by the DAC NF 604 after the operations of 6008.

During 6009, the DAC NF 604 signals a response to the external AF 606. The response may comprise an indication that the encrypted digital documents have been stored by the DAC NF.

During 6010, the external AF 606 signals the UE 601. This signalling confirms that the digital documents have been sent.

During 6011, the Metaverse AF 607 signals the DAC NF 604. This signalling may request at least one digital document. This signalling may identify the at least one digital document by providing document details (e.g., tag, number, etc.). This signaling may comprise a public key of the Metaverse AF 607 (or an indication thereof). This signalling may be provided directly, or indirectly (e.g., via an NEF).

During 6012, the DAC NF 604 validates the Metaverse AF 607 authorization against the stored digital document(s) corresponding to the requested at least one digital document, regenerates the new key using document details (e.g., tag, number, etc.), decrypts the stored digital document using it, and then encrypts the decrypted stored digital document using the Metaverse AF's public key.

During 6013, the DAC NF 604 signals the Metaverse AF 607. This signalling may comprise the digital document(s) encrypted using the public key of the Metaverse AF 607.

During 6014, the Metaverse AF 607 decrypts the received digital document(s) using the Metaverse AF's private key. The Metaverse AF 607 may use the decrypted DAC content for any service provided by the Metaverse AF 607 to the UE 601 (e.g., for fetching at least one of: a user identity document, an avatar for a gaming application, etc.).

In the example of FIG. 6, a key is created per document, with each document being tagged with a name (e.g., tag=PersonalCard1) and document number and the document data (e.g., card number and other credit/debit card details) being encrypted using a key.

The keys used at the DAC-NF do not have to be stored at the DAC-NF after a digital document has been encrypted at the DAC-NF using that key, as it may be regenerated at any time using the document details (e.g., tag, number, etc.) and the predefined KDF known only to the DAC-NF.

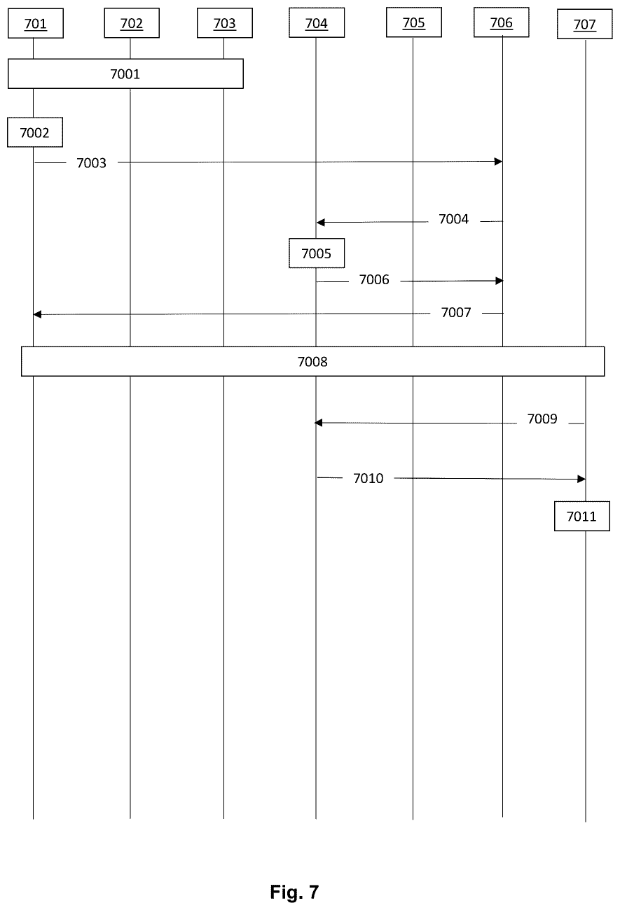

FIG. 7 illustrates another (fourth) example mechanism for facilitating storage and/or retrieval of digital asset data.

FIG. 7 illustrates signalling that may be performed between that may be performed between a UE 701, a radio access network (RAN) 702, an authentication function 703, a DAC NF 704, a user plane function (UPF) 705, an external AF 706, and a Metaverse AF 707. The external AF 706 and Metaverse AF 707 may be located outside of the 5G network (e.g., over the internet). The RAN 702, the authentication function 703, the DAC NF 704, and UPF 705 may be located in a 5GS.

During 7001, the UE 701 and authentication function 703 perform primary authentication. During this process, K_{AUSF} and DAC-KID may be generated by each apparatus.

During 7002, the UE 701 generates a unique key, encrypts the digital document using the unique key. The key generation by the UE may be performed for obtaining a new key per document. The key generation by the UE may be performed for obtaining a same key for multiple documents stored in the 5G-DAC NF.

During 7003, the UE 701 signals the external AF 706. This signalling may send encrypted digital documents (e.g., digital documents that are encrypted using the unique key as an encryption key) and a list of authorized application functions, tag identifiers and document numbers for each digital documents. This signalling may comprise the DAC-KID.

During 7004, the external AF 706 signals the DAC NF 704. This signalling may send the encrypted digital documents (e.g., digital documents that are encrypted using the unique key as an encryption key) and the list of authorized application functions, tag identifiers and document numbers for each digital documents. This signalling may comprise the DAC-KID.

During 7005, the DAC NF 704 stores the encrypted digital document(s) received during 7004 with a details tag comprising a tag and document number for each encrypted digital document.

During 7006, the DAC NF 704 signals the external AF 706. This signalling may indicate that the encrypted digital document(s) of 7004 have been successfully stored at the DAC NF 704.

During 7007, the external AF 706 signals the UE 701. This signalling may indicate that the encrypted digital document(s) of 7003 have been successfully stored at the DAC NF 704.

During 7008, the UE securely shares the unique key corresponding to the document with details tag and document number with the Metaverse AF 707 according to any secure process. The Metaverse AF 707 may be provided with an indication of the tag(s) and document number(s) of the digital document(s) stored at the DAC NF 704.

During 7009, the Metaverse AF 707 signals the DAC NF 704. This signalling may comprise a request to retrieve at least one digital document associated with a specific document tag and document number. This signalling may comprise the specific document tag and document number. This signalling may comprise the DAC-KID.

During 7010, the DAC NF 704 signals the Metaverse AF 707. This signaling may comprise the at least one digital document requested during 7009.

During 7011, the Metaverse AF 707 decrypts the at least one digital document received during 7010 using the unique key previously received from the UE. The Metaverse AF 707 may use the decrypted DAC content for any service provided by the Metaverse AF 707 to the UE 701 (e.g., for fetching at least one of: a user identity document, an avatar for a gaming application, etc.).

With the approach of FIG. 7, the 5GC cannot determine the unencrypted form of the content of the digital document.

Further, if the UE 701 renews (e.g., updates to a new value) the unique key associated with the digital document, the UE may re-encrypt the DAC content using the renewed unique and send the re-encrypted content to the DAC-NF and share the new key with Metaverse AF.

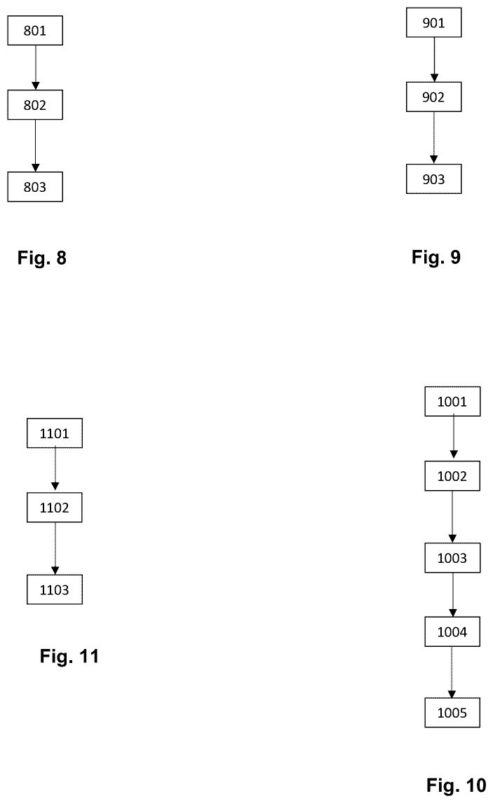

FIGS. 8 to 11 illustrate operations that may be performed by at least one of the apparatus of FIGS. 4 and/or 5. It is therefore understood that the features found below may find functional equivalence in at least one of the features mentioned above with respect to these Figs. Further, it is understood that the features of FIGS. 4 and/or 5 may be used to illustrate how the presently described techniques may be implemented in a technical system.

FIG. 8 illustrates operations that may be performed by an apparatus for a user equipment. The apparatus for a user equipment may comprise the user equipment. The apparatus for a user equipment may comprise an entity (e.g., a client application being deployed remote from the user equipment) that is authorized to perform functions on behalf of the user equipment.

During 801, the apparatus encrypts a digital asset using a first key to form an encrypted digital asset. The first key may comprise K_{Metaverse}.

During 802, the apparatus provides the encrypted digital asset and an index for the encrypted digital asset to a first network function. The first network function may be a DAC network function. The first network function may be the first network function of any of FIGS. 9 to 11. The index may comprise a counter value, a random value, and/or a key identifier (e.g., DAC-KID), as described further below.

During 803, the apparatus provides an identification of the encrypted digital asset to a first entity. The first entity may comprise a metaverse application function. The first entity may comprise a trusted application function, an untrusted application function, and/or a network function. The first entity may be the first entity of any of FIGS. 9 to 11. The digital asset may comprise DAC content.

The providing the identification of the encrypted digital asset may comprise providing the first entity with a first identifier and at least one document identifier for identifying a document comprised in the encrypted digital asset.

The first identifier may comprise a subscriber identifier. The first identifier may comprise a global public subscriber identifier.

The apparatus may generate the first identifier by inputting an authentication key into a second key derivation function, and combining an output of the second key derivation function with an identifier of a user of the user equipment to form the first identifier. The first identifier may comprise a key identifier, such as DAC-KID.

The combining may comprise combining the output of the second key derivation function with the identifier of the user and an identifier of an administrative domain to which the user is registered.

The apparatus may determine that a flag has been set to indicate that the first identifier is to be generated by inputting the authentication key into the first key derivation function prior to said inputting.

The apparatus may generate the first key by inputting a third key into a first key derivation function. The third key may comprise a key derived and/or determined during a primary authentication process (e.g., K_{AUSF}), and/or a key derived and/or determined prior to a primary authentication process (e.g., a long-term key, as described above).

The generating may further comprise inputting a random value and/or counter value into the first key derivation function.

The providing the identification may comprise providing the identification with a session establishment request.

The identification may comprise the index.

FIG. 9 illustrates operations that may be performed by an apparatus for a first network function. The first network function may be the first network function of any of FIGS. 8, and/or 10 to 11. The first network function may comprise a DAC NF.

During 901, the apparatus receives an encrypted digital asset and an index for the encrypted digital asset. The digital asset and the index may be as described above in relation to FIG. 8.

During 902, the apparatus receives, from a first entity, a request for the encrypted digital asset. The first entity may be as described in relation to any of FIGS. 8, and/or 10 to 11.

During 903, the apparatus provides the encrypted digital asset and the index to the first entity.

The apparatus may determine that the first entity is authorised to receive the encrypted digital asset prior to providing the encrypted digital asset to the first entity.

FIG. 10 illustrates operations that may be performed by an apparatus for a first entity. The first entity may be the first entity of any of FIGS. 8 to 9, and/or 11. The first entity may comprise a metaverse AF. The first entity may comprise a metaverse application function. The first entity may comprise a trusted application function, an untrusted application function, and/or a network function.

During 1001, the apparatus receives, from a user equipment, an identification of an encrypted digital asset. The digital asset may be as described above in relation to FIG. 8. The user equipment may be as described above in relation to FIG. 8.

During 1002, the apparatus retrieves the encrypted digital asset from a first network function. The first network function may be as described above in relation to any of FIGS. 8 to 9.

During 1003, the apparatus receives an index for the encrypted digital asset from the user equipment or the first network function. The index may be as described above in relation to FIG. 8.

During 1004, the apparatus retrieves a first decryption key from an authentication function using the index and the identification of the encrypted digital asset. The authentication function may be as described below in relation to FIG. 11.

During 1005, the apparatus decrypts the encrypted digital asset.

FIG. 11 illustrates operations that may be performed by an apparatus for an authentication function. The authentication function may be as described in relation to FIG. 10. The authentication function may comprise an entity for performing a primary authentication with the user equipment apparatus of FIG. 8 prior to 1101 being performed.

During 1101, the apparatus receives, from a first entity, a request for a first decryption key for decrypting an encrypted digital asset, the request comprising an index for the encrypted digital asset. The first entity may be as described in relation to FIG. 10. The digital index and digital asset may be as described in relation to any of FIGS. 8 to 10.

During 1102 the apparatus obtains the decryption key using the index.

During 1103, the apparatus provides the decryption key to the first entity.

The obtaining the decryption key may comprise using a value of the received index and an identification of the encrypted digital asset to generate the decryption key.

The obtaining the decryption key may comprise using a value of the received index and an identification of the encrypted digital asset to retrieve a previously generated decryption key.

In any of the above-mentioned examples of FIGS. 8 to 11, the index may comprise a random value, a counter value, a key, and/or a key identifier (e.g., DAC-KID).

It is understood that references in the above to various network functions (e.g., to an AMF, an SMF, etc.) may comprise apparatus that perform at least some of the functionality associated with those network functions. Further, an apparatus comprising a network function may comprise a virtual network function instance of that network function.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the examples described herein.

In the above, different examples are described using, as an example of an access architecture to which the described techniques may be applied, a radio access architecture based on long term evolution advanced (Long Term Evolution (LTE) Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) Internet Protocol multimedia subsystems (IMS) and expected 6G systems or any combination thereof.

As provided herein, various examples are described in the detailed description. In general, some examples may be implemented in hardware or special purpose circuits, software code, logic or any combination thereof. For example, some examples may be implemented in hardware, while other examples may be implemented in firmware or software code which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software code, firmware code, special purpose circuits or logic, general purpose hardware or controller or other computing devices, or some combination thereof.

The examples may be implemented by computer software code stored in a memory and executable by at least one data processor of the involved entities or by hardware, or by a combination of software code and hardware.

The memory referred to herein may be of any type suitable to the local technical environment and may be implemented using any suitable data storage technology, such as semiconductor based memory devices, magnetic memory devices and systems, optical memory devices and systems, fixed memory and removable memory.

The (data) processors referred to herein may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Further in this regard it should be noted that any procedures, e.g., as in FIG. 8, and/or FIG. 9, and/or FIG. 10, and/or FIG. 11, and/or otherwise described previously, may represent operations of a computer program being deployed by at least one processor comprised in an apparatus (where a computer program comprises instructions for causing an apparatus to perform at least one action, the instructions being represented as software code stored on at least one memory), or interconnected logic circuits, blocks and functions, or a combination of operations of a computer program being deployed by at least one processor comprised in an apparatus and logic circuits, blocks and functions. The software code may be stored on memory, such as physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software cade, such as:
   (i) a combination of analogue and/or digital hardware circuit(s) with software/firmware code and
   (ii) any portions of hardware processor(s) with software code (including digital signal processor(s)), software code, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software code (e.g., firmware) for operation, but the software code may not be present when it is not needed for operation.

This definition of circuitry applies to all uses of this term in this application, including in any claims. As a further example, as used herein, the term circuitry also covers an implementation of merely a hardware circuit or processor (or multiple processors) or portion of a hardware circuit or processor and its (or their) accompanying software and/or firmware code. The term circuitry also covers, for example integrated device.

Implementations of the disclosure may be practiced in various components, such as integrated circuit modules. The design of integrated circuits is by and large a highly automated process. Complex and powerful software tools are available for converting a logic level design into a semiconductor circuit design ready to be etched and formed on a semiconductor substrate.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “non-transitory,” as used herein, is a limitation of the medium itself (i.e., tangible, not a signal) as opposed to alimitation on data storage persistency (e.g., RAM vs. ROM).

The scope of protection sought for various examples of the disclosure is set out by the independent claims. The examples and features, if any, described in this specification that do not fall under the scope of the independent claims are to be interpreted as examples useful for understanding the disclosure.

The foregoing description has provided by way of non-limiting examples a full and informative description of example implementations of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of the examples described herein. Indeed, there is a further implementation comprising a combination of one or more examples with any of the other examples described herein.

1. An apparatus for a user equipment, the apparatus comprising:
at least one processor, and
at least one memory storing instructions that, when executed by the at least one processor, cause the apparatus at least to perform:
encrypting a digital asset using a first key to form an encrypted digital asset;
providing the encrypted digital asset and an index for the encrypted digital asset to a first network function; and
providing an identification of the encrypted digital asset to a first entity.

2. An apparatus as claimed in claim 1, wherein the providing the identification of the encrypted digital asset comprises providing the first entity with a first identifier and at least one document identifier for identifying a document comprised in the encrypted digital asset.

3. An apparatus as claimed in claim 2, wherein the first identifier comprises a subscriber identifier.

4. An apparatus as claimed in claim 3, wherein the first identifier comprises a global public subscriber identifier.

5. An apparatus as claimed in claim 2, wherein the at least one memory further causes the apparatus to perform: generating the first identifier by:
inputting an authentication key into a second key derivation function; and
combining an output of the second key derivation function with an identifier of a user of the user equipment to form the first identifier.

6. An apparatus as claimed in claim 5, wherein the combining comprises combining the output of the second key derivation function with the identifier of the user and an identifier of an administrative domain to which the user is registered.

7. An apparatus as claimed in claim 5, wherein the at least one memory further causes the apparatus to perform:
determining that a flag has been set to indicate that the first identifier is to be generated by inputting the authentication key into the first key derivation function prior to said inputting.

8. An apparatus as claimed in claim 1, wherein the at least one memory further causes the apparatus to perform:
generating the first key by inputting a third key into a first key derivation function.

9. An apparatus as claimed in claim 8, the generating further comprising inputting a random value and/or counter value into the first key derivation function.

10. An apparatus as claimed in claim 1, wherein the providing the identification comprises providing the identification with a session establishment request.

11. An apparatus as claimed in claim 1, wherein the identification comprises the index.

12. An apparatus for a first network function, the apparatus comprising means for performing:
receiving an encrypted digital asset and an index for the encrypted digital asset;
receiving, from a first entity, a request for the encrypted digital asset; and
providing the encrypted digital asset and the index to the first entity.

13. An apparatus as claimed in claim 12, the apparatus comprising:
at least one processor; and
at least one memory storing instructions that, when executed by the at least one processor, cause the apparatus at least to perform:
determining that the first entity is authorised to receive the encrypted digital asset prior to providing the encrypted digital asset to the first entity.

14. An apparatus for a first entity, the apparatus comprising:
at least one processor; and
at least one memory storing instructions that, when executed by the at least one processor, cause the apparatus at least to perform:
receiving, from a user equipment, an identification of an encrypted digital asset;
retrieving the encrypted digital asset from a first network function;
receiving an index for the encrypted digital asset from the user equipment or the first network function;
retrieving a first decryption key from an authentication function using the index and the identification of the encrypted digital asset; and
decrypting the encrypted digital asset.

15. An apparatus as claimed in claim 1, wherein the index comprises a random value, a counter value, and/or a key.
